(19) United States
(12) Patent Application Publication
(10) Pub. No.: US 2024/0399932 A1
(43) Pub. Date: Dec. 5, 2024

(54) WORK VEHICLE

(71) Applicant: Komatsu Ltd., Tokyo (JP)

(72) Inventor: Yuta Hoshino, Tokyo (JP)

(73) Assignee: Komatsu Ltd., Tokyo (JP)

(21) Appl. No.: 18/697,073

(22) PCT Filed: Dec. 9, 2022
(86) PCT No.: PCT/JP2022/045449

§ 371 Date: Mar. 29, 2024

(30) Foreign Application Priority Data
Dec. 9, 2021 (JP) 2021-200388

(51) Int. Cl. B60L 58/33; B60L 1/00

(52) U.S. Cl. CPC B60L 58/33; B60L 1/20; B60L 2200/36

(57) ABSTRACT

A work vehicle includes an electric motor, a traveling body, a hydraulic oil tank, and a hydraulic pump, and an accumulator. The hydraulic pump is driven by regenerative electric power of the electric motor, which is generated by braking of the traveling body, and pumps a hydraulic oil in the hydraulic oil tank. The accumulator accumulates the pressure of the hydraulic oil pumped from the hydraulic pump.

### TECHNICAL FIELD

The present disclosure relates to a work vehicle.

Priority is claimed on Japanese Patent Application No. 2021-200388, filed Dec. 9, 2021, the content of which is incorporated herein by reference.

### BACKGROUND ART

In an open pit mine, a transport vehicle travels downhill continuously for a long time in a loading state in some cases. In such a case, in order to keep a speed of traveling downhill constant, it is necessary to continue to operate a brake while traveling downhill. Patent Document 1 discloses an electric drive type dump truck that converts regenerative electric power generated by braking into heat energy with a resistor (retarder grid).

### CITATION LIST

### Patent Document

[Patent Document 1]
Japanese Unexamined Patent Application, First Publication No. 2014-054117

### SUMMARY OF INVENTION

### Technical Problem

In order to exhibit a braking force by converting the regenerative electric power into heat with the retarder grid, a large retarder grid that can consume a large amount of energy generated when traveling downhill is necessary. The retarder grid, which is mounted on a large dump truck, is provided on a platform. The platform is a flat plate portion provided above front wheels of a vehicle body. However, in a case of providing a structure, other than the retarder grid, on the platform, it is preferable to reduce the size of the retarder grid. For example, in order to provide a hydrogen tank on the platform of the transport vehicle driven by a fuel cell, it is preferable to reduce a proportion of the retarder grid on the platform. In order to reduce the size of the retarder grid, it is necessary to reduce electric power consumed by the retarder grid.

An object of the present disclosure is to provide a work vehicle that can consume regenerative electric power.

### Solution to Problem

According to an aspect of the present disclosure, there is provided a work vehicle including an electric motor, a traveling body configured to be driven by the electric motor, a hydraulic oil tank configured to store a hydraulic oil, a hydraulic pump configured to be driven by regenerative electric power of the electric motor, which is generated by braking of the traveling body, and to pump the hydraulic oil in the hydraulic oil tank, and an accumulator configured to accumulate the pressure of the hydraulic oil pumped from the hydraulic pump.

### Advantageous Effects of Invention

According to the aspect, the work vehicle can consume regenerative electric power.

### BRIEF DESCRIPTION OF DRAWINGS

FIG. 1 is a perspective view schematically showing a transport vehicle according to a first embodiment.

FIG. 2 is a schematic block diagram showing the configuration of a hydraulic system included in the transport vehicle according to the first embodiment.

FIG. 3 is a schematic block diagram showing the configuration of an electric system included in the transport vehicle according to the first embodiment.

FIG. 4 is a schematic block diagram showing the configuration of a control device according to the first embodiment.

FIG. 5 is a flowchart showing retarder control for the control device according to the first embodiment.

### DESCRIPTION OF EMBODIMENTS

### First Embodiment

### <<Configuration of Transport Vehicle 10>>

Hereinafter, embodiments will be described in detail with reference to the drawings.

A transport vehicle 10 according to a first embodiment is a rigid frame type dump truck that transports a crushed stone material or the like mined in a mine. The transport vehicle 10 is driven by a fuel cell 41 fueled by a hydrogen gas. The transport vehicle 10 is an example of a work vehicle.

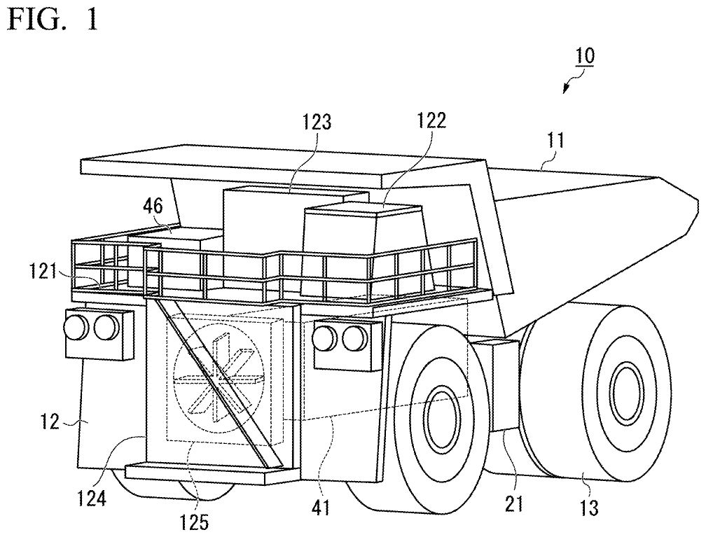

FIG. 1 is a perspective view schematically showing the transport vehicle 10 according to the first embodiment. The transport vehicle 10 includes a dump body 11, a vehicle body 12, and a traveling device 13.

The dump body 11 is a member to be loaded with a load. At least a part of the dump body 11 is disposed above the vehicle body 12. The dump body 11 performs a dumping operation and a lowering operation. Through the dumping operation and the lowering operation, the dump body 11 is adjusted to be in a dumping posture and a loading posture. The dumping posture refers to a posture in which the dump body 11 is raised. The loading posture refers to a posture in which the dump body 11 is lowered.

The dumping operation refers to an operation of separating the dump body 11 from the vehicle body 12 and inclining the dump body in a dumping direction. The dumping direction is the rear of the vehicle body 12. In the embodiment, the dumping operation includes raising a front end portion of the dump body 11 and inclining the dump body 11 rearward. Through the dumping operation, a loading surface of the dump body 11 is inclined downward toward the rear.

The lowering operation refers to an operation of bringing the dump body 11 closer to the vehicle body 12. In the embodiment, the lowering operation includes lowering of the front end portion of the dump body 11.

In a case of carrying out dumping work, the dump body 11 performs the dumping operation to change from the loading posture to the dumping posture. In a case where the dump body 11 is being loaded with a load, the load is discharged rearward from a rear end portion of the dump body 11 through the dumping operation. In a case of carrying out loading work, the dump body 11 is adjusted to be in the loading posture.

The vehicle body 12 includes a vehicle body frame (not shown). The vehicle body 12 rotatably supports the dump body 11 via a hinge pin provided on the vehicle body frame. The vehicle body 12 is supported by the traveling device 13. A platform 121 is provided at the vehicle body frame above front wheels of the traveling device 13. The platform 121 is a flat plate configuring an upper surface of the vehicle body frame. An operator cab 122, a control cabinet 123, and a retarder grid 46 are provided on the platform 121. In addition, the fuel cell 41 is provided on the vehicle body frame. In a front surface of the vehicle body 12, an opening portion is provided in a front portion of the fuel cell 41, and a grill 124 is provided in the opening portion. A fan 125 for cooling the fuel cell 41 is provided between the grill 124 and the fuel cell 41. The fan 125 cools the fuel cell 41 by drawing outside air into the vehicle body frame via the grill 124.

The control cabinet 123 converts electric power. Specifically, the control cabinet 123 performs electric power control among the fuel cell 41, various types of motors, and the retarder grid 46.

The retarder grid 46 is a resistor for absorbing regenerative electric power generated by braking of the traveling device 13. The retarder grid 46 converts the regenerative electric power into heat energy.

The traveling device 13 supports the vehicle body 12. The traveling device 13 causes the transport vehicle 10 to travel. The traveling device 13 causes the transport vehicle 10 to advance or retreat. At least a part of the traveling device 13 is disposed below the vehicle body 12. The traveling device 13 includes a pair of front wheels and a pair of rear wheels. The front wheels are steering wheels, and the rear wheels are driving wheels.

### <<Configuration of Hydraulic System 20>>

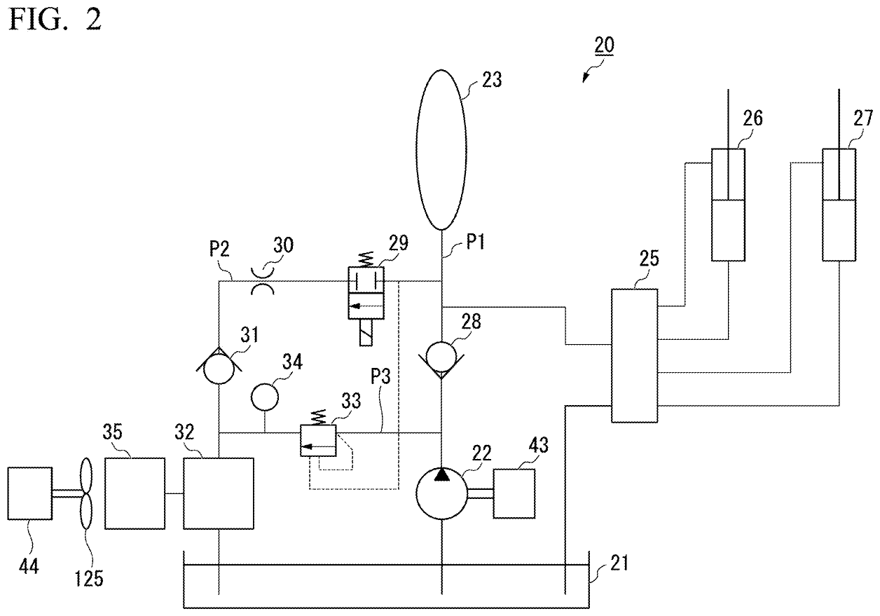

FIG. 2 is a schematic block diagram showing a configuration of a hydraulic system 20 included in the transport vehicle 10 according to the first embodiment.

As shown in FIG. 2, the hydraulic system 20 of the transport vehicle 10 includes a hydraulic oil tank 21, a hydraulic pump 22, an accumulator 23, a control valve 25, a steering cylinder 26, and a work equipment cylinder 27.

A discharge opening of the hydraulic pump 22 is connected to the accumulator 23 via a first flow path P1. A first check valve 28 is provided in the first flow path P1. The first check valve 28 allows a flow of a hydraulic oil from the hydraulic pump 22 to the accumulator 23 and blocks a flow of the hydraulic oil from the accumulator 23 toward the hydraulic pump 22. Accordingly, the pressure of the hydraulic oil output by the hydraulic pump 22 is accumulated in the accumulator 23.

The hydraulic system 20 includes a second flow path P2 that connects an intermediate portion of the first flow path P1 between the accumulator 23 and the first check valve 28 and the hydraulic oil tank 21 to each other. A 2-port solenoid valve 29, a choke 30, a second check valve 31, and an oil cooler 32 are provided in the second flow path P2 in order from a first flow path P1 side. The 2-port solenoid valve 29 is configured to be capable of switching between conduction and cutoff of the first flow path P1. When regenerative electric power is generated and the hydraulic pump 22 is operated, the 2-port solenoid valve 29 makes the first flow path P1 conductive. The choke 30 restricts the flow rate of a hydraulic oil flowing in the first flow path P1 and generates a pressure loss. The temperature of the hydraulic oil passing through the choke 30 rises due to the pressure loss. The second check valve 31 allows a flow of the hydraulic oil from the first flow path P1 to the hydraulic oil tank 21 and blocks a flow of the hydraulic oil from the hydraulic oil tank 21 toward the first flow path P1. The oil cooler 32 cools the hydraulic oil flowing in the second flow path P2 through heat exchange with a refrigerant. The refrigerant of the oil cooler 32 is cooled by a radiator 35. The radiator 35 is provided between the grill 124 shown in FIG. 1 and the fan 125. That is, the fan 125 according to the first embodiment is a cooling device that cools the fuel cell 41 and is also a cooling device that cools the hydraulic oil.

The hydraulic system 20 includes a third flow path P3 that connects an intermediate portion of the first flow path P1 between the hydraulic pump 22 and the first check valve 28 and an intermediate portion of the second flow path P2 between the oil cooler 32 and the second check valve 31 to each other. A relief valve 33 and a flow meter 34 are provided in the third flow path P3. The relief valve 33 opens when the pressure of the first flow path P1 exceeds a predetermined relief pressure. Accordingly, the pressure of the accumulator 23 is kept at the relief pressure or less. In addition, the relief valve 33 closes when the pressure of the first flow path P1 falls below a predetermined pressure. Accordingly, the pressure of the accumulator 23 is kept at the predetermined pressure or more. The flow meter 34 measures the flow rate of the hydraulic oil flowing in the third flow path P3.

The control valve 25 is connected to an intermediate portion of the first flow path P1 between the accumulator 23 and the first check valve 28.

The control valve 25 adjusts the flow rate of a hydraulic oil supplied to the steering cylinder 26 and the work equipment cylinder 27 in response to operation of an operation device (not shown) by an operator.

The steering cylinder 26 controls a traveling direction of the traveling device 13 by changing angles of the front wheels of the traveling device 13. A first port of the control valve 25 is connected to the intermediate portion of the first flow path P1 between the accumulator 23 and the first check valve 28. The hydraulic oil is supplied from one having a higher pressure of the hydraulic pump 22 and the accumulator 23 to the first port. A second port of the control valve 25 is connected to the hydraulic oil tank 21. The hydraulic oil returned from the steering cylinder 26 and the work equipment cylinder 27 is supplied to the hydraulic oil tank 21 via the second port. A third port and a fourth port of the control valve 25 are connected to the steering cylinder 26. A fifth port and a sixth port of the control valve 25 are connected to the work equipment cylinder 27.

The work equipment cylinder 27 has a head attached to the dump body 11 and has a rod attached to the vehicle body 12. As the work equipment cylinder 27 expands and contracts, the posture of the dump body 11 with respect to the vehicle body 12 changes. That is, by driving the work equipment cylinder 27, the dumping operation and the lowering operation of the dump body 11 can be realized.

### <<Configuration of Electric System 40>>

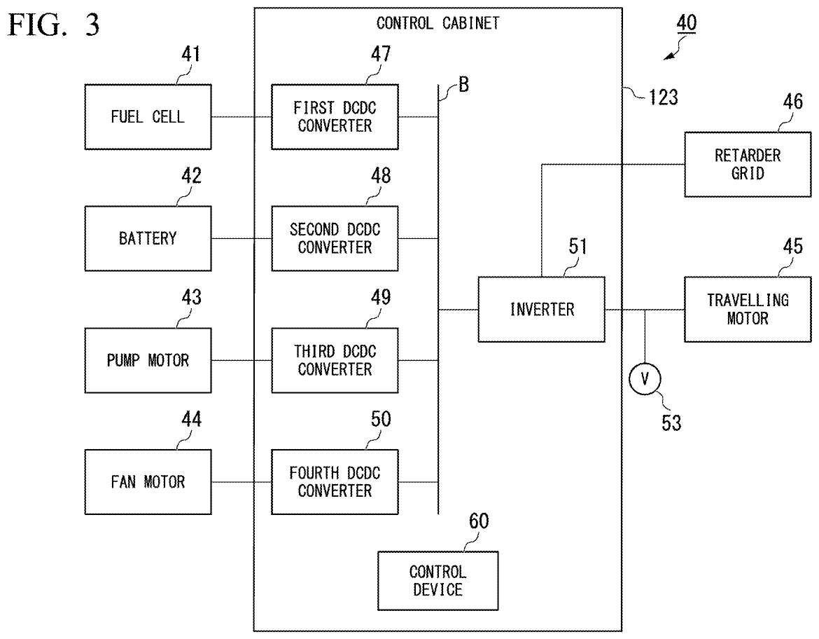

FIG. 3 is a schematic block diagram showing a configuration of an electric system 40 included in the transport vehicle 10 according to the first embodiment. The electric system 40 includes the fuel cell 41, a battery 42, a pump motor 43, a fan motor 44, a traveling motor 45, the retarder grid 46, a first DCDC converter 47, a second DCDC converter 48, a third DCDC converter 49, a fourth DCDC converter 50, an inverter 51, and a control device 60. The first DCDC converter 47, the second DCDC converter 48, the third DCDC converter 49, the fourth DCDC converter 50, the inverter 51, and the control device 60 are provided in the control cabinet 123.

The fuel cell 41 causes a hydrogen gas supplied from a hydrogen tank (not shown) and oxygen contained in outside air to react with each other to generate electric power. The first DCDC converter 47 supplies direct current electric power generated by the fuel cell 41 to the bus B.

The second DCDC converter 48 supplies electric power charged in the battery 42 to the bus B. In addition, the second DCDC converter 48 charges the battery 42 by adjusting a voltage of direct current electric power flowing in the bus B and supplying the voltage to the battery 42. That is, the second DCDC converter 48 is an example of a charging device. The battery 42 includes a battery management unit (BMU) (not shown) that monitors a state of the battery 42. The BMU measures the charging rate of the battery 42 and outputs measurement data to the control device 60.

The pump motor 43 drives the hydraulic pump 22 shown in FIG. 2. The third DCDC converter 49 adjusts the voltage of the direct current electric power flowing in the bus B to supply the voltage to the pump motor 43.

The fan motor 44 drives the fan 125 shown in FIG. 1. The fourth DCDC converter 50 adjusts the voltage of the direct current electric power flowing in the bus B to supply the voltage to the fan motor 44.

The traveling motor 45 is a three-phase alternating current electric motor that drives the traveling device 13. The inverter 51 converts the direct current electric power flowing in the bus B into three-phase alternating current electric power and supplies the three-phase alternating current electric power to the traveling motor 45. In addition, the inverter 51 converts regenerative electric power generated by the traveling motor 45 through braking of the traveling device 13 into direct current electric power and supplies the direct current electric power to the bus B. The traveling motor 45 is provided with a voltmeter 52. The voltmeter 52 measures a voltage applied to the traveling motor 45. The voltmeter 52 transmits measurement data to the control device 60.

The control device 60 controls the first DCDC converter 47, the second DCDC converter 48, the third DCDC converter 49, the fourth DCDC converter 50, the inverter 51, and the 2-port solenoid valve 29 shown in FIG. 2 based on measurement data received from the flow meter 34, the BMU of the battery 42, and the voltmeter 52.

### <<Configuration of Control Device 60>>

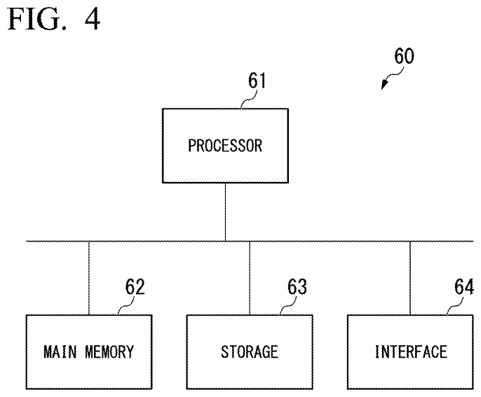

FIG. 4 is a schematic block diagram showing a configuration of the control device 60 according to the first embodiment.

The control device 60 is a computer including a processor 61, a main memory 62, a storage 63, and an interface 64.

The processor 61 reads out a program from the storage 63, develops the program on the main memory 62, and executes processing according to the program. Examples of the processor 61 include a central processing unit (CPU), a graphic processing unit (GPU), and a microprocessor.

The program may be for realizing some of functions to be exhibited by the control device 60. For example, the program may implement the functions in combination with other programs already stored in the storage or in combination with other programs installed in other devices. In addition, in the other embodiment, the control device 60 may include a custom large scale integrated circuit (LSI) such as a programmable logic device (PLD) in addition to the configuration or instead of the configuration. Examples of the PLD include a programmable array logic (PAL), a generic array logic (GAL), a complex programmable logic device (CPLD), and a field programmable gate array (FPGA). In this case, some or all of the functions realized by the processor 61 may be realized by the integrated circuit. Such an integrated circuit is also included as an example of the processor.

Examples of the storage 63 include a magnetic disk, a magneto-optical disk, an optical disk, and a semiconductor memory, or the like. The storage 63 may be an internal medium directly connected to the bus or may be an external medium connected to the control device 60 via the interface 64 or a communication line. In addition, in a case where the program is distributed to the control device 60 via the communication line, the control device 60 that has received the distribution may develop the program on the main memory 62 and execute the processing. In at least one embodiment, the storage 63 is a non-transitory tangible storage medium.

In addition, the program may be for realizing some of the functions described above. Further, the program may be a so-called differential file (differential program) that realizes the functions described above in combination with other programs already stored in the storage 63.

### <<Retarder Control by Control Device>>

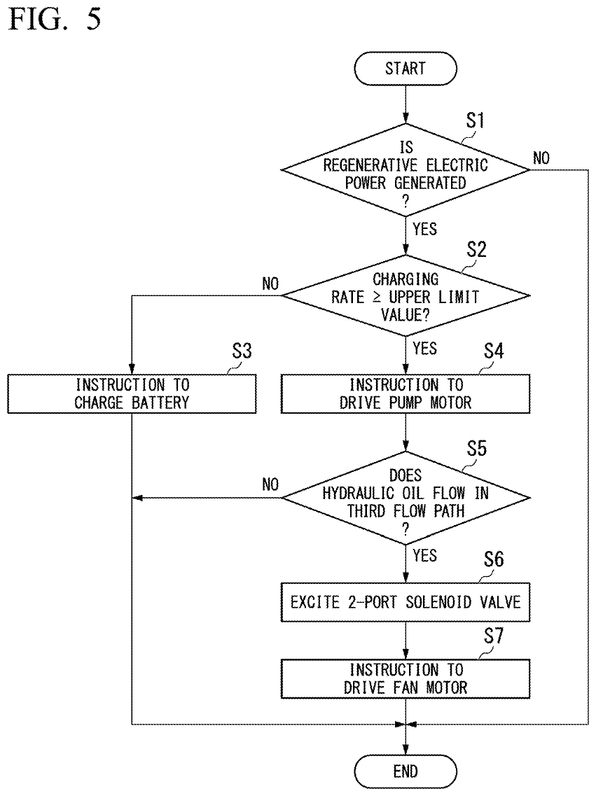

FIG. 5 is a flowchart showing retarder control by the control device 60. The control device 60 executes retarder control shown in FIG. 5 for each fixed cycle.

First, the control device 60 determines whether or not regenerative electric power is generated by the traveling motor 45 based on measurement data received from the voltmeter 52 (Step S1). The control device 60 determines presence or absence of the regenerative electric power, for example, by the sign of a voltage value. In a case where the regenerative electric power is not generated (Step S1: NO), the control device 60 ends the retarder control.

On the other hand, in a case where the regenerative electric power is generated (Step S1: YES), the control device 60 determines whether or not the charging rate of the battery 42 is an upper limit value or more based on measurement data received from the BMU of the battery 42 (Step S2). In a case where the charging rate of the battery 42 is less than the upper limit value (Step S2: NO), the control device 60 outputs an instruction to charge the battery 42 to the second DCDC converter 48 (Step S3). Accordingly, the control device 60 can reduce electric power consumed by the retarder grid 46 by causing the battery 42 to absorb the regenerative electric power. Therefore, in a case where the charging rate of the battery 42 is less than the upper limit value, the control device 60 ends the retarder control.

On the other hand, in a case where the charging rate of the battery 42 is the upper limit value or more (Step S2: YES), the control device 60 outputs an instruction to drive the pump motor 43 to the third DCDC converter 49 (Step S4). Accordingly, the pump motor 43 drives the hydraulic pump 22.

Next, the control device 60 determines whether or not a hydraulic oil flows in the third flow path P3 based on measurement data of the flow meter 34 (Step S5). In a case where the hydraulic oil does not flow in the third flow path P3 (Step S5: NO), it can be seen that the pressure of the hydraulic oil is accumulated in the accumulator 23 by the hydraulic pump 22. In this case, the pump motor 43 can absorb the regenerative electric power due to a load generated by pressure accumulation in the accumulator 23. Therefore, in a case where the hydraulic oil does not flow in the third flow path P3 (Step S5: NO), the control device 60 ends the retarder control.

On the other hand, in a case where the hydraulic oil flows in the third flow path P3 (Step S5: YES), it can be seen that the pressure of the accumulator 23 exceeds the relief pressure of the relief valve 33, and further pressure accumulation in the accumulator 23 is impossible. In a case where the hydraulic oil flows in the third flow path P3 (Step S5: YES), the control device 60 excites the 2-port solenoid valve 29 (Step S6) and starts flowing of the hydraulic oil to the second flow path P2. In addition, the control device 60 outputs an instruction to drive the fan motor 44 to the fourth DCDC converter 50 (Step S7). Accordingly, the pump motor 43 can absorb the regenerative electric power due to the load generated by the choke 30. In addition, also the fan motor 44 can absorb the regenerative electric power. In addition, as the refrigerant of the oil cooler 32 is cooled by the rotation of the fan 125 via the radiator 35, the hydraulic oil of which the temperature is raised by the choke 30 can be cooled.

### Workings and Effects

As described above, the control device 60 of the transport vehicle 10 according to the first embodiment operates the hydraulic pump 22 with regenerative electric power of the traveling motor 45 generated by braking of the traveling device 13 and accumulates the pressure of the hydraulic oil in the accumulator 23. Accordingly, the transport vehicle 10 can collect the regenerative electric power through pressure accumulation in the accumulator 23 by the hydraulic pump 22. Hydraulic energy accumulated in the accumulator 23 can be used in driving the steering cylinder 26 or the work equipment cylinder 27 via the control valve 25.

In addition, the transport vehicle 10 according to the first embodiment includes the 2-port solenoid valve 29 controlled in an open state when the traveling motor 45 outputs regenerative electric power and the hydraulic pump 22 is being driven and the choke 30 provided downstream of the 2-port solenoid valve 29. Accordingly, even when filling of the accumulator 23 with a pressure is ended, the regenerative electric power can be converted into heat energy by a pressure loss of a hydraulic oil in the choke 30. In addition, in a case where the regenerative electric power is not generated or a case where the regenerative electric power is collected by the battery 42, the pressure accumulated in the accumulator 23 can be prevented from being uselessly consumed by closing the 2-port solenoid valve 29. The transport vehicle 10 according to the other embodiment may not include the second flow path P2.

In addition, the transport vehicle 10 according to the first embodiment includes the oil cooler 32 that is driven by regenerative electric power of the traveling motor 45 and that cools a hydraulic oil downstream of the choke 30. Accordingly, the transport vehicle 10 can collect the regenerative electric power through driving of the oil cooler 32 and lower the temperature of the hydraulic oil, which is further raised by a pressure loss. The transport vehicle 10 according to the other embodiment may not include the oil cooler 32. In addition, the oil cooler 32 according to the first embodiment cools the hydraulic oil with a refrigerant cooled by the fan 125 and the radiator 35, but is not limited thereto. For example, the oil cooler 32 according to the other embodiment may be a refrigerator that moves heat of the refrigerant through compression and expansion of the refrigerant. In this case, a compressor included in the refrigerator is driven by the regenerative electric power.

In addition, the transport vehicle 10 according to the first embodiment includes the second DCDC converter 48 that charges the battery 42 with regenerative electric power, and the control device 60 drives the hydraulic pump 22 when the charging rate of the battery 42 is the upper limit value or more. Accordingly, the transport vehicle 10 can absorb the regenerative electric power in two steps of charging of the battery 42 and pressure accumulation in the accumulator 23.

In addition, the fan 125 of the transport vehicle 10 according to the first embodiment is driven by regenerative electric power of the traveling motor 45 and cools the fuel cell 41. Accordingly, the regenerative electric power can be absorbed by the rotation of the fan 125. The control device 60 according to the first embodiment rotates the fan 125 in a case where the charging rate of the battery 42 is the upper limit value or more and the pressure of the accumulator 23 is the relief pressure or more, but is not limited thereto. For example, the control device 60 according to the other embodiment may drive the fan motor 44 regardless of the charging rate of the battery 42 and the pressure of the accumulator 23 in a case where the traveling motor 45 generates the regenerative electric power.

As described above, the transport vehicle 10 according to the first embodiment can reduce regenerative electric power consumed by the retarder grid 46. In a case where the traveling route of the transport vehicle 10 is known in advance, the size of the retarder grid 46 can be designed based on an electric power amount that can be absorbed by the battery 42, the accumulator 23, the choke 30, the oil cooler 32, and the fan 125. Accordingly, the size of the retarder grid 46 can be reduced, and a space for providing the other structure on the platform 121 can be secured. Examples of the other structure provided on the platform 121 include the hydrogen tank filled with a hydrogen gas supplied to the fuel cell 41.

Since the hydraulic pump 22 and the accumulator 23 are configured to be widely mounted on the electric transport vehicle 10, the transport vehicle 10 according to the first embodiment can be easily manufactured by modifying the existing transport vehicle 10.

### Other Embodiment

Although one embodiment has been described in detail with reference to the drawings hereinbefore, a specific configuration is not limited to the description above, and various design changes are possible. That is, in the other embodiment, order of processing described above may be changed as appropriate. In addition, some of the processing may be performed in parallel.

The control device 60 according to the embodiments described above may be configured by a single computer, or the configuration of the control device 60 may be divided and disposed into a plurality of computers, and the plurality of computers may function as the control device 60 by cooperating with each other.

The transport vehicle 10 has been described as an example of a work machine in the embodiments described above, but is not limited thereto. For example, the work machine according to the other embodiment may be other work machines such as a hydraulic excavator, a wheel loader, and a motor grader.

### INDUSTRIAL APPLICABILITY

According to the aspect, the work vehicle can consume regenerative electric power.

### REFERENCE SIGNS LIST

10: Transport vehicle
11: Dump body
12: Vehicle body
121: Platform
122: Operator cab
123: Control cabinet
124: Grill
125: Fan
13: Traveling device
20: Hydraulic system
21: Hydraulic oil tank
22: Hydraulic pump
23: Accumulator
25: Control valve
26: Steering cylinder
27: Work equipment cylinder
28: First check valve
29: 2-port solenoid valve
30: Choke
31: Second check valve
32: Oil cooler
33: Relief valve
34: Flow meter
35: Radiator
40: Electric system
41: Fuel cell
42: Battery
43: Pump motor
44: Fan motor
45: Traveling motor
46: Retarder grid
47: First DCDC converter
48: Second DCDC converter
49: Third DCDC converter
50: Fourth DCDC converter
51: Inverter
52: Voltmeter
60: Control device
61: Processor
62: Main memory
63: Storage
64: Interface
B: Bus
P1: First flow path
P2: Second flow path
P3: Third flow path

1. A work vehicle comprising:
an electric motor;
a traveling body configured to be driven by the electric motor;
a hydraulic oil tank configured to store a hydraulic oil;
a hydraulic pump configured to be driven by regenerative electric power of the electric motor, which is generated by braking of the traveling body, and to pump the hydraulic oil in the hydraulic oil tank; and
an accumulator configured to accumulate a pressure of the hydraulic oil pumped from the hydraulic pump.

2. The work vehicle according to claim 1, further comprising:
a first flow path configured to connect the accumulator and the hydraulic pump to each other;
a second flow path configured to connect an intermediate portion of the first flow path and the hydraulic oil tank to each other;
a solenoid valve provided in the second flow path and configured to be controlled in an open state while the electric motor outputs the regenerative electric power and the hydraulic pump is driven; and
a choke provided downstream of the solenoid valve.

3. The work vehicle according to claim 2, further comprising:
a cooling device configured to be driven by the regenerative electric power of the electric motor and to cool the hydraulic oil downstream of the choke.

4. The work vehicle according to claim 1, further comprising:
a battery; and
a charging device configured to charge the battery with the regenerative electric power of the electric motor,
wherein the hydraulic pump is driven when a charging rate of the battery is a predetermined value or more.

5. The work vehicle according to claim 1, further comprising:
a fuel cell configured to supply electric power to the electric motor; and
a cooling device configured to be driven by the regenerative electric power of the electric motor and to cool the fuel cell.
